(19) United States
(12) Patent Application Publication
(10) Pub. No.: US 2025/0348029 A1
(43) Pub. Date: Nov. 13, 2025

(54) HEATING DEVICE, FIXING DEVICE, AND IMAGE FORMING APPARATUS

(71) Applicant: Takuya SESHITA, Kanagawa (JP)

(72) Inventor: Takuya SESHITA, Kanagawa (JP)

(21) Appl. No.: 19/188,012

(22) Filed: Apr. 24, 2025

(30) Foreign Application Priority Data
May 9, 2024 (JP) 2024-076374

(51) Int. Cl. G03G 15/20

(52) U.S. Cl. CPC G03G 15/2039; G03G 15/2028; G03G 2215/2003

(57) ABSTRACT

A heating device includes a heater, a temperature sensor detecting a temperature of the heater, a compression coil spring having a first end coil, a second end coil, and an active coil between the first and second end coils, a receiver receiving the second end coil, and a sensor holder including a holding portion and a boss. The holding portion holds the temperature sensor at one side of the sensor holder. The boss supports the first end coil at another side of the sensor holder. The first end coil is inserted into the boss in an insertion direction. The boss has a fixing portion contacting an inner face of the first end coil, and the active coil is spaced apart from the fixing portion in the insertion direction.

### CROSS-REFERENCE TO RELATED APPLICATION

This patent application is based on and claims priority pursuant to 35 U.S.C. § 119(a) to Japanese Patent Application No. 2024-076374, filed on May 9, 2024, in the Japan Patent Office, the entire disclosure of which is hereby incorporated by reference herein.

### BACKGROUND

### Technical Field

The present disclosure relates to a heating device, a fixing device, and an image forming apparatus. In particular, the present disclosure relates to a structure to prevent a compression coil spring for pressing a temperature sensor against a heat source from being erroneously assembled.

### Related Art

An image forming apparatus such as a copier or a printer includes a fixing device as an example of a heating device. The fixing device heats a sheet to fix an image onto the sheet. A typical fixing device includes a pair of rotators contacting each other to form a nip and a heater heating at least one of the rotators. After the heater heats one of or both rotators to a predetermined temperature, a sheet enters a nip between the rotators to apply heat and pressure to an unfixed image on the sheet, and the unfixed image is fixed onto the sheet.

The fixing device includes a temperature sensor that detects the temperature of the heater or the rotator in order to appropriately maintain the temperature of the heater and prevent an excessive temperature rise. The temperature sensor is pressed against the heater by a spring with a predetermined pressing force.

### SUMMARY

The present disclosure described herein provides a heating device including a heater, a temperature sensor, a compression coil spring, a receiver, and a sensor holder. The temperature sensor detects a temperature of the heater. The compression coil spring has a first end coil at one end of the compression coil spring, a second end coil at another end of the compression coil spring, and an active coil between the first end coil and the second end coil. The receiver receives the second end coil. The sensor holder includes a holding portion and a boss. The holding portion holds the temperature sensor at one side of the sensor holder. The boss supports the first end coil at another side of the sensor holder. The first end coil is inserted into the boss in an insertion direction. The boss has a fixing portion contacting an inner face of the first end coil, and the active coil is spaced apart from the fixing portion in the insertion direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an image forming apparatus;

FIG. 2 is a schematic diagram illustrating a basic configuration of a fixing device;

FIG. 3 is a plan view of a heater in the fixing device of FIG. 2;

FIG. 4 is a diagram illustrating a configuration of a temperature control mechanism of a heater;

FIG. 5 is a diagram illustrating a configuration of a fixing device according to a first embodiment to illustrate the feature of the first embodiment;

FIGS. 6A and 6B are enlarged views of a characteristic portion of the fixing device of FIG. 5;

FIG. 6C is a schematic diagram illustrating the direction of a spring load;

FIG. 7 is a schematic diagram illustrating a characteristic portion according to a second embodiment;

FIGS. 8A and 8B are schematic diagrams illustrating a characteristic portion according to a third embodiment;

FIGS. 9A to 9C are schematic diagrams illustrating a characteristic portion according to a fourth embodiment;

FIG. 10 is a schematic diagram of another fixing device in which the above embodiments are applicable;

FIG. 11 is a schematic diagram of still another fixing device in which the above embodiments are applicable;

FIG. 12 is a schematic diagram of still another fixing device in which the above embodiments are applicable;

FIG. 13A is an enlarged view of a characteristic portion according to a comparative example; and

FIG. 13B is an enlarged view of a characteristic portion according to a comparative example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

With reference to the drawings, descriptions are given below of embodiments of the present disclosure. In the drawings for illustrating embodiments of the present disclosure, elements or components identical or similar in function or shape are given identical reference numerals as far as distinguishable, and redundant descriptions are omitted.

An overall configuration of an image forming apparatus is described below.

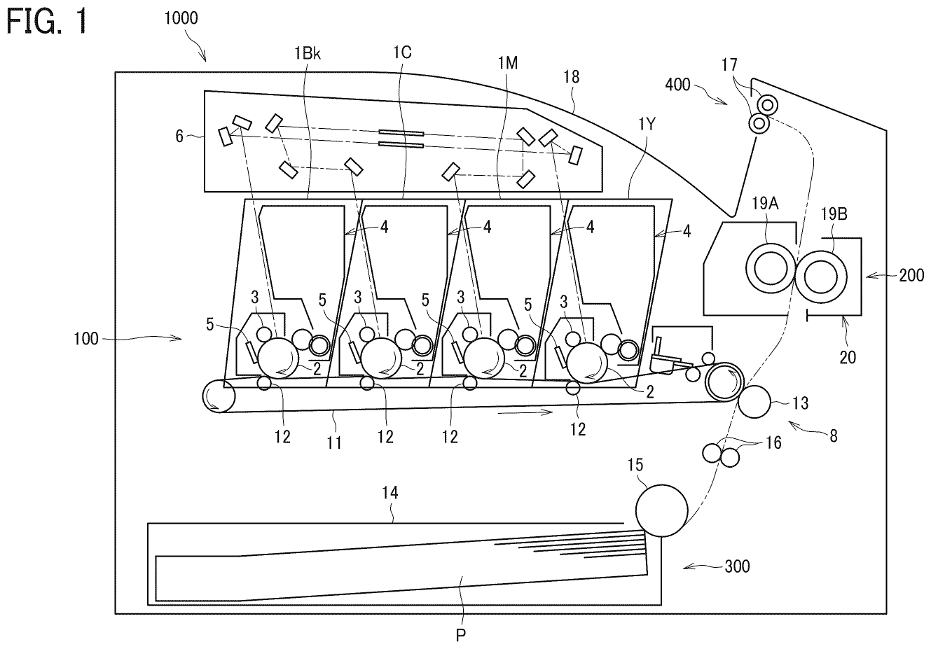

FIG. 1 is a schematic diagram illustrating a configuration of an image forming apparatus 1000. In the following description, the “image forming apparatus” includes a printer, a copier, a facsimile machine, or a multifunction peripheral having at least two of printing, copying, scanning, and facsimile functions.

The term “image formation” includes the formation of images with meanings such as characters and figures and the formation of images with no meanings such as patterns. With reference to FIG. 1, a description is given below of the overall configuration and operation of an image forming apparatus 1000. As illustrated in FIG. 1, the image forming apparatus 1000 includes an image forming section 100, a fixing section 200, a sheet feeder 300, and a sheet ejection section 400.

The image forming section 100 is described below.

The image forming section 100 forms an image on a sheet as a recording medium. The image forming section 100 includes four image forming units 1Y, 1M, 1C, and 1Bk, an exposure device 6, and a transfer device 8. Each of the four image forming units 1Y, 1M, 1C, and 1Bk includes a photoconductor 2, a charger 3, a developing device 4, and a cleaner 5.

The photoconductor 2 bears an electrostatic latent image on the surface of the photoconductor 2 and rotates. Examples of the photoconductor 2 includes an endless-shaped photoconductor belt in addition to a drum-shaped photoconductor. The drum-shaped photoconductor 2 is, for example, an inorganic photoconductor such as amorphous silicon or selenium, or an organic photoconductor such as titanyl phthalocyanine.

As the organic photoconductor, there are a laminated type photoconductor and a single-layer type photoconductor. The laminated type photoconductor has a laminated structure containing a layer (a charge generation layer) in which charge-generating materials such as non-metallic phthalocyanine or titanyl phthalocyanine are dispersed in a binder resin and a layer (a charge transport layer) in which charge transport materials are dispersed in a binder resin. These layers are stacked on a support such as an aluminum drum. The single-layer type photoconductor has a single-layer structure with a photosensitive layer containing both charge-generating materials and charge transport materials dispersed in a binder resin on a support. In the single-layer type photoconductor, it is also possible to add hole transport agents and electron transport agents as charge transport materials to the photosensitive layer. Additionally, the option exists to include an undercoat layer between the support and either the charge-generation layer in the laminated type photoconductor or the photosensitive layer in the single-layer type photoconductor.

The charger 3 charges the surface of the photoconductor 2. The charging system of the charger 3 is not limited to a particular system as long as the charger 3 applies a voltage to the surface of the photoconductor 2 to uniformly charge the surface of the photoconductor 2. The charging system of the charger 3 can be selected as appropriate depending on the purpose. Specifically, examples of the charger 3 include a contact type charger such as a conductive or semiconductive charging roller, a magnetic brush, a fur brush, a film, or a rubber blade, and a non-contact type charger using corona discharge.

The developing device 4 supplies toner as the developer to the electrostatic latent image on the photoconductor 2 to form a toner image. The developing devices 4 accommodate toners (developers) of different colors such as yellow, magenta, cyan, and black in the image forming units 1Y, 1M, 1C, and 1Bk, respectively, corresponding to color separation components of a color image.

The cleaner 5 removes the toner and other foreign matters remaining on the photoconductor 2. Examples of the cleaner 5 include a cleaning blade disposed to be in contact with the surface of the photoconductor 2.

The exposure device 6 exposes the charged surface of the photoconductor 2 to form the electrostatic latent image on the surface of the photoconductor 2. The exposure system of the exposure device 6 is not limited to a particular system as long as the exposure device 6 can expose the charged surface of the photoconductor 2 and can be appropriately selected depending on the purpose. Specific examples of the exposure device include various exposure devices such as a copying optical system, a rod lens array system, a laser optical system, a liquid crystal shutter optical system, and an LED optical system.

The transfer device 8 transfers an image onto a sheet. The transfer device 8 includes an intermediate transfer belt 11, primary transfer rollers 12, and a secondary transfer roller 13.

The intermediate transfer belt 11 is an endless belt stretched by a plurality of support rollers. Four primary transfer rollers 12 are disposed inside the loop of the intermediate transfer belt 11.

Each of the primary transfer rollers 12 is in contact with the corresponding photoconductor 2 via the intermediate transfer belt 11 to form a primary transfer nip between the intermediate transfer belt 11 and each photoconductor 2. On the other hand, the secondary transfer roller 13 contacts an outer circumferential surface of the intermediate transfer belt 11 to form a secondary transfer nip between the secondary transfer roller 13 and the intermediate transfer belt 11.

An elastic intermediate transfer belt may be used as the intermediate transfer belt 11. The elastic intermediate transfer belt may include, for example, a rigid base layer having relatively flexibility and a flexible elastic layer layered on the base layer. In addition, the intermediate transfer belt 11 may include a guide on the inner circumferential surface of the intermediate transfer belt to prevent the intermediate transfer belt 11 from meandering.

The fixing section 200 is described below.

The fixing section 200 includes a fixing device 20 that heats the sheet to fix the image on the sheet. The fixing device 20 includes a pair of rotators 19A and 19B contacting each other and a heater heating at least one of the pair of rotators 19A and 19B.

The sheet feeder 300 is described below. The sheet feeder 300 supplies the sheet to the image forming section 100. The sheet feeder 300 includes a sheet tray 14 to store sheets P as heated members and a feed roller 15 to feed the sheet P from the sheet tray 14.

Examples of the “heated member” include not only a sheet of paper but also an overhead projector (OHP) transparency sheet, a fabric, a metallic sheet, a plastic film, and a prepreg sheet including carbon fibers previously impregnated with resin. Examples of the “sheet” further include thick paper, a postcard, an envelope, thin paper, coated paper (e.g., coat paper and art paper), and tracing paper, in addition to plain paper.

The sheet ejection section 400 is described below.

The sheet ejection section 400 ejects the sheet P to the outside of the image forming apparatus 1000. The sheet ejection section 400 includes an output roller pair 17 to eject the sheet P to the outside of the image forming apparatus 1000 and an output tray 18 to place the sheet P ejected by the output roller pair 17.

An image forming operation is described below.

With continued reference to FIG. 1, the image forming operation of the image forming apparatus 1000 is described below. The image forming operation is started in response to an instruction from an operation panel or external terminals. In each of the image forming units 1Y, 1M, 1C, and 1Bk, the photoconductor 2 starts rotating.

Subsequently, the charger 3 uniformly charges the surface of the photoconductor 2 to a high electric potential. Based on image data of a document read by a document reading device or print data instructed to print by a terminal, the exposure device 6 exposes the charged surface of each of the photoconductors 2.

As a result, the electric potential at an exposed portion on the surface of each of the photoconductors 2 is decreased. Thus, the electrostatic latent image is formed on the surface of each of the photoconductors 2. The developing devices 4 supply toners to the photoconductors 2, respectively, to form toner images of different colors on the photoconductors 2, respectively.

As the photoconductors 2 rotate, the toner images on the photoconductors 2 reach primary transfer nips defined by the positions of the primary transfer rollers 12, respectively. At the primary transfer nips, the toner images are transferred from the photoconductors 2 onto the intermediate transfer belt 11 driven to rotate so as to be sequentially superimposed on one another.

Thus, the full-color toner image is formed on the intermediate transfer belt 11. The image forming operation is not limited to the above-described full color image forming operation that uses all four image forming units 1Y, 1M, 1C, and 1Bk. Alternatively, the image forming apparatus 1000 can form a monochrome toner image by using any one of the four image forming units 1Y, 1M, 1C, and 1Bk, or can form a bicolor toner image or a tricolor toner image by using two or three of the image forming units 1Y, 1M, 1C, and 1Bk.

After the toner image is transferred to the intermediate transfer belt 11, the cleaner 5 removes residual toner remaining on the photoconductor 2 from the surface of the photoconductor 2. As a result, the cleaner 5 removes foreign matter such as residual toner on the photoconductor 2.

The full-color toner image transferred to the intermediate transfer belt 11 is conveyed to the secondary transfer nip defined by the secondary transfer roller 13 in accordance with the rotation of the intermediate transfer belt 11. At the secondary transfer nip, the full-color toner image is transferred from the intermediate transfer belt 11 onto the sheet P.

The sheet P is fed from the sheet feeder 300. After the start of the image forming operation, the feed roller 15 rotates to feed the sheet P from the sheet tray 14.

Before the sheet P reaches the secondary transfer nip, the sheet P fed from the sheet tray 14 is brought into contact with a timing roller pair 16 and temporarily stopped. After the sheet P is temporarily stopped, the timing roller pair 16 is rotated at a predetermined time to convey the sheet P to the secondary transfer nip in synchronization with the full-color toner image formed on the intermediate transfer belt 11 reaching the secondary transfer nip. As a result, the full-color toner image is transferred to the sheet P.

The sheet P bearing the full-color toner image is conveyed to the fixing section 200. In the fixing section 200, the sheet P passes between the pair of rotators 19A and 19B, and thus the full-color toner image on the sheet P is heated and pressed to fix the full-color toner image to the sheet P.

Then, the sheet P bearing the fixed toner image is conveyed to the sheet ejection section 400. In the sheet ejection section 400, the output roller pair 17 ejects the sheet P onto the output tray 18. Thus, a series of image forming operations is completed.

The basic configuration of the fixing device 20 is described below.

FIG. 2 is a schematic diagram illustrating the basic configuration of the fixing device 20. As illustrated in FIG. 2, the fixing device 20 includes a heater 23, a heater holder 24, and a stay 25 in addition to the pair of rotators 19A and 19B.

The pair of rotators 19A and 19B includes a first rotator 19A that is a fixing belt 21 disposed to contact an unfixed toner image on a surface of the sheet P. The pair of rotators 19A and 19B includes a second rotator 19B that is a pressure roller 22 disposed to face the fixing belt 21.

A pressure member such as a spring presses the fixing belt 21 and the pressure roller 22 to be in contact with each other. As a result, a fixing nip N is formed between the fixing belt 21 and the pressure roller 22.

The fixing belt 21 is an endless belt including a tubular base and a release layer on an outer circumferential surface of the base. The base is made of metal such as nickel or stainless steel or resin such as polyimide.

The release layer is made of, for example, tetrafluoroethylene-perfluoroalkylvinylether copolymer (PFA), polytetrafluoroethylene (PTFE), polyimide, polyetherimide, or polyether sulfide (PES). The release layer of the fixing belt 21 facilitates the separation of toner contained in the toner image from the fixing belt 21 and prevents the sheet P from adhering to and wrapping around the fixing belt 21.

The fixing belt 21 may include an elastic layer between the base and the release layer. Examples of the material of the elastic layer include rubber such as silicone rubber, silicone rubber foam, and fluororubber. The elastic layer of the fixing belt 21 prevents the fixing belt 21 from forming slight surface asperities, thus facilitating uniform conduction of heat to the toner image on the sheet P to enhance fixing quality.

The pressure roller 22 includes a solid or hollow cored bar, an elastic layer on the outer circumferential surface of the cored bar, and a release layer on the outer circumferential surface of the elastic layer. The cored bar is made of metal such as iron.

Examples of the material of the elastic layer include silicone rubber, silicone rubber foam, and fluororubber. The release layer is made of fluororesin such as PFA or PTFE.

The heater 23 heats the fixing belt 21. The heater 23 has a plate shape or a planar shape and contacts the inner circumferential surface of the fixing belt 21.

At a position where the fixing belt 21 faces the pressure roller 22, the heater 23 contacts the inner circumferential surface of the fixing belt 21 to form the fixing nip N between the fixing belt 21 and the pressure roller 22. The heater 23 may be in direct contact with the inner circumferential surface of the fixing belt 21 or may be in indirect contact with the inner circumferential surface of the fixing belt 21 via a low-friction slide sheet. In the present specification, unless otherwise specified, the meaning of “contact” includes direct contact and indirect contact. In the direct contact, a first member is in contact with a second member via no member. In the indirect contact, a third member is in contact with a fourth member via a fifth member.

The heater 23 includes a base 50, resistive heat generators 51, and an insulation layer 52. The resistive heat generators 51 are disposed on the base 50 and is covered with the insulation layer 52.

When power is supplied to the resistive heat generators 51, the resistive heat generators 51 generate heat. The heat is transferred to the inner circumferential surface of the fixing belt 21 via the insulation layer 52 to heat the fixing belt 21. Alternatively, the heater 23 may be turned inside out so that the base 50 is in contact with the inner circumferential surface of the fixing belt 21. In this case, since the heat of the resistive heat generators 51 is transmitted to the fixing belt 21 through the base 50, it is preferable that the base 50 be made of a material with high thermal conductivity.

The base 50 is made of material having heat resistance and insulation properties, such as ceramic such as alumina or aluminum nitride, or non-metal material such as glass or mica. Interposing another insulation layer between the base 50 and the resistive heat generators 51 enables using conductive material such as metal as the material of the base 50. Low-cost aluminum or stainless steel is favorable as the metal material of the base 50. To reduce the temperature unevenness of the heater 23 and enhance image quality, the base 50 may be made of material having high thermal conductivity, such as copper, graphite, or graphene. Graphene is formed by bonding of carbon atoms and has a sheet shape.

The resistive heat generators 51 are formed by, for example, screen-printing. The resistive heat generators 51 are produced by, for example, mixing silver-palladium (AgPd) and glass powder into a paste. The paste is coated on the base 50 by screen printing. Subsequently, the base 50 is fired to form the resistive heat generators 51.

The material of the resistive heat generator 51 may contain a resistance material, such as silver alloy (e.g., AgPt) or ruthenium oxide (RuO₂) in addition to silver-palladium. The insulation layer 52 may be made of, for example, heat-resistant glass.

The heater holder 24 holds the heater 23. The heater holder 24 accommodates the heater 23 in a recess 24a to restrict the movement of the heater 23 in the vertical direction in FIG. 2 and the direction orthogonal to the paper surface in which FIG. 2 is drawn.

Since the heater holder 24 is heated to a high temperature by heat from the heater 23, the heater holder 24 is preferably made of a heat resistant material. In particular, the heater holder 24 made of heat-resistant resin having low thermal conduction, such as a liquid crystal polymer (LCP), reduces unnecessary heat transfer from the heater 23 to the heater holder 24, thus increasing the heating efficiency of the heater 23.

The stay 25 supports the heater holder 24. The stay 25 supports a stay side face of the heater holder 24. The stay side face is opposite a nip side face of the heater holder 24. The nip side face faces the pressure roller 22. Accordingly, the stay 25 prevents the heater holder 24 from being bent by a pressing force of the pressure roller 22. As a result, the fixing nip N having a uniform width is formed between the fixing belt 21 and the pressure roller 22. The stay 25 is preferably made of iron-based metal such as steel use stainless (SUS) or steel electrolytic cold commercial (SECC) to enhance the rigidity.

The fixing device 20 operates as follows.

When the image forming operation starts, a driver starts driving to rotate the pressure roller 22 in a direction indicated by an arrow in FIG. 2, and the rotation of the pressure roller 22 rotates the fixing belt 21. A power source starts supplying power to the heater 23, and the heater 23 generates heat to heat the fixing belt 21.

After the temperature of the fixing belt 21 reaches a specified target temperature, the sheet P bearing the unfixed image is conveyed to the fixing nip N between the fixing belt 21 and the pressure roller 22. As a result, the unfixed toner image on the sheet P is heated and pressed to be fixed on the sheet P. The sheet P is ejected from the fixing nip N and conveyed to the sheet ejection section 400.

A heater configuration is described below.

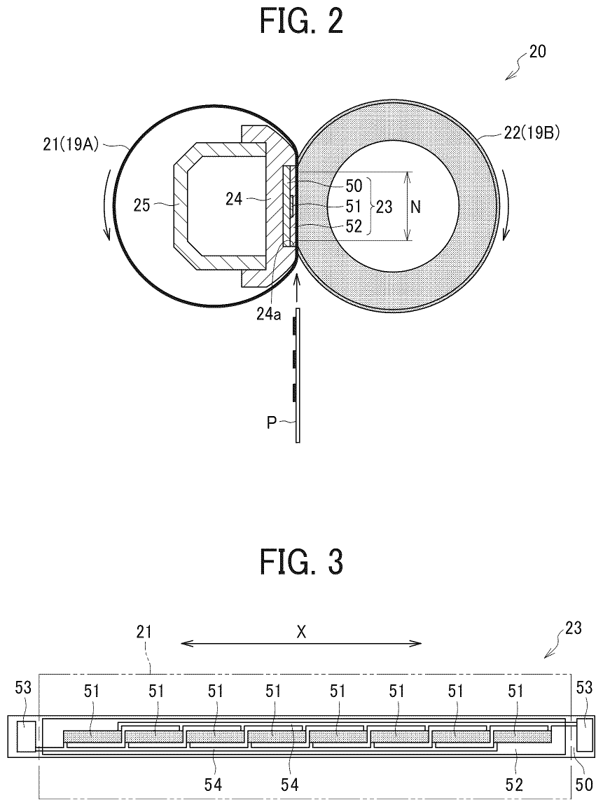

FIG. 3 is a plan view of the heater 23. As illustrated in FIG. 3, the heater 23 includes a pair of electrodes 53 and multiple power supply lines 54 in addition to the base 50, the resistive heat generators 51, and the insulation layer 52.

The base 50 is a longitudinal plate arranged to extend in the longitudinal direction X of the fixing belt 21. The resistive heat generators 51 are arranged at intervals in the longitudinal direction of the base 50 (that is, the direction indicated by the arrow X in FIG. 3).

A gap between neighboring resistive heat generators 51 is preferably 0.2 mm or more, more preferably 0.4 mm or more from the viewpoint of maintaining the insulation between the neighboring resistive heat generators 51. In addition, the gap between the resistive heat generators 51 adjacent to each other is preferably 5 mm or less, and is more preferably 1 mm or less, from the viewpoint of reducing temperature unevenness in the longitudinal direction because a too large gap between the resistive heat generators 51 adjacent to each other easily causes a temperature drop in the gap.

The pair of electrodes 53 are disposed on both ends of the base 50 in the longitudinal direction. Each electrode 53 is connected to the resistive heat generators 51 via the multiple power supply lines 54.

The resistive heat generators 51 are electrically coupled in parallel to the pair of electrodes 53. The arrangement, number, shape of each of the resistive heat generators 51, the electrodes 53, and the power supply lines 54 are not limited to the example illustrated in FIG. 3 and may be appropriately changed.

The power supply lines 54 are covered with the insulation layer 52 in the same manner as the resistive heat generators 51 in order to obtain insulation and durability. However, the insulation layer 52 does not cover the electrodes 53 to expose the electrodes 53 as power supply terminals so as to be connected to the connectors. Connecting the connectors to the electrodes 53 enables the power source (an alternating-current (AC) power source) disposed in the body of the image forming apparatus to supply power to the resistive heat generators 51.

A temperature control mechanism is described below.

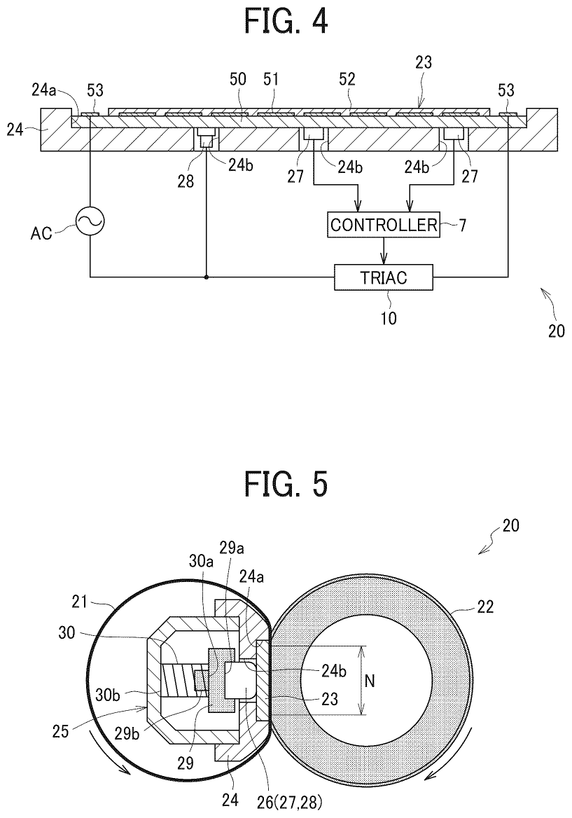

FIG. 4 is a diagram illustrating a configuration of a temperature control mechanism of the heater 23. As illustrated in FIG. 4, the temperature control mechanism in the fixing device 20 includes thermistors 27, a thermostat 28, a triac 10, and a controller 7 to control temperatures of the heater 23.

The thermistor 27 is a temperature sensor to control the temperature of the heater 23 and maintain the temperature of the heater 23 at a predetermined temperature. The thermostat 28 is the temperature sensor to prevent an excessive temperature rise of the heater 23, unlike the thermistor 27.

The thermistors 27 and the thermostat 28 are disposed so as to be in contact with the back face of the heater 23 through through holes 24b of the heater holder 24. The back face of the heater 23 is opposite to a face of the heater 23 that is the face in contact with the fixing belt 21. The thermistors 27 and the thermostat 28 may be in direct contact with the heater 23 or may be in indirect contact with the heater 23 via a high thermal conductor.

The triac 10 serves as an energization controller that controls a turn-on duty supplied from an AC power source to the heater 23 based on control signals from the controller 7. The turn-on duty is defined as a ratio of a power-on time per a control cycle.

The controller 7 includes a microcomputer including, for example, a central processing unit (CPU), a read-only memory (ROM), a random-access memory (RAM), and an input and output (I/O) interface. The controller 7 outputs the control signal to control the triac 10 based on the temperature detected by the thermistor 27, and the triac 10 controls the turn-on duty based on the control signal. As a result, the temperature of the heater 23 is maintained at a predetermined target temperature.

When the thermostat 28 detects an abnormal temperature rise of the heater 23, the thermostat 28 operates to cut off the power supply to the heater 23. In the example of FIG. 4, the thermistors 27 are disposed at the center and one end of the heater 23 in the longitudinal direction, and the thermostat 28 is disposed at the other end of the heater 23 with respect to the center in the longitudinal direction, but the position and number of the thermistors 27 and the thermostat 28 are not limited to the example of FIG. 4 and may be appropriately changed.

The configuration of characteristic portions of the fixing device 20 according to a first embodiment is described below.

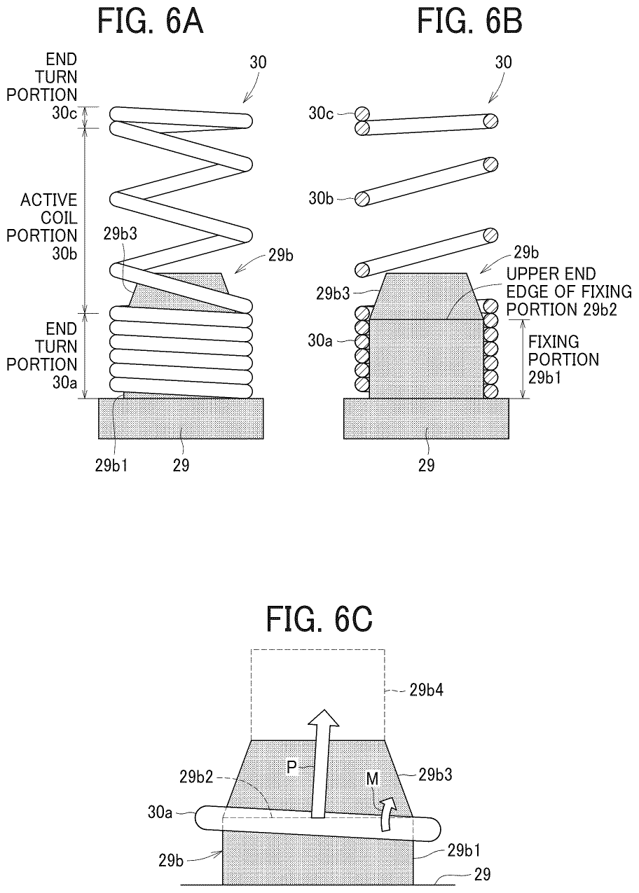

FIGS. 5, 6A, and 6B are diagrams illustrating the configuration of the fixing device 20 according to the first embodiment to illustrate the characteristic portions of the first embodiment. With reference to FIG. 5, a structure to hold a temperature sensor 26 is described.

The fixing device 20 according to the first embodiment of the present disclosure includes a sensor holder 29 as the temperature sensor holder and a compression coil spring 30 made of metal as the biasing member. The temperature sensor 26 may be the thermistor 27 or the thermostat 28. The stay 25 covers the upper side, the lower side, and the left side of the compression coil spring 30 in FIG. 5. As a result, it is difficult to visually check (inspect) whether the compression coil spring 30 is correctly assembled from the outside.

The sensor holder 29 has a holding portion 29a having a recessed shape to hold the temperature sensor 26. The temperature sensor 26 is fitted into the holding portion 29a of the sensor holder 29 to hold the temperature sensor 26 in the sensor holder 29. The compression coil spring 30 is disposed between the sensor holder 29 and the stay 25.

The compression coil spring 30 biases the temperature sensor 26 toward the heater 23. In other words, the compression coil spring 30 presses the temperature sensor 26 against the heater 23 in the pressing direction. As a result, the temperature sensor 26 is held to be pressed against the heater 23. In FIG. 5, the cross-sectional shape of the heater 23 is simplified.

The compression coil spring 30 extends from one end that is referred to as a first end coil 30a to the other end that is referred to as the second end coil 30c in the longitudinal direction of the compression coil spring 30. The first end coil 30a is closer to the temperature sensor 26 than the second end coil 30c. The sensor holder 29 includes a boss 29b to which the first end coil 30a is inserted in an insertion direction and is fitted. As a result, the sensor holder 29 has the holding portion 29a to hold the temperature sensor 26 at one side of the sensor holder 29 and the boss 29b to support the first end coil 30a at another side of the sensor holder 29. Fitting the first end coil 30a of the compression coil spring 30 into the boss 29b of the sensor holder 29 positions the first end coil 30a of the compression coil spring 30 with respect to the sensor holder 29.

On the other hand, since the second end coil 30c of the compression coil spring 30 simply contacts the inner face of the stay 25, the second end coil 30c is not positioned with respect to the stay 25. Since the inner face of the stay 25 functioning as a receiver to receive the second end coil 30c of the compression coil spring 30 is a flat face having no projection, the second end coil 30c of the compression coil spring 30 is held so as to be displaceable along the inner face of the stay 25.

As illustrated in FIGS. 6A and 6B, the first end coil 30a is formed at one end of the compression coil spring 30. An outer peripheral surface of the boss 29b formed on a back surface of the sensor holder 29 is pressed and fitted to an inside of the first end coil 30a.

The inner diameter of the first end coil 30a is formed to be slightly smaller than the outer diameter of the boss 29b (the inner diameter of the first end coil 30a <the outer diameter of the boss 29b). The above-described structure causes the compression coil spring 30 not to be easily removed after the first end coil 30a of the compression coil spring 30 is fitted to the outer peripheral surface of the boss 29b. The above-described structure can prevent the compression coil spring 30 from accidentally falling off after the compression coil spring 30 is assembled.

The boss 29b includes a cylindrical fixing portion 29b1 and a tapered portion 29b3. The fixing portion 29b1 is pressed and fitted to the inside of the first end coil 30a. As a result, the fixing portion contacts an inner face of the first end coil 30a. The tapered portion 29b3 is tapered from an upper end edge 29b2 of the fixing portion 29b1 toward the tip of the boss 29b. In other words, the tapered portion 29b3 is on the fixing portion 29b1. As illustrated by the broken line in FIG. 6B, the boss 29b may include a cylindrical guide 29b4 protruding from the tip of the tapered portion 29b3. The guide 29b4 facilitates the assembly of the compression coil spring 30 to the boss 29b.

As illustrated in FIG. 6A, the compression coil spring 30 has the first end coil 30a and the second end coil 30c at both ends of the compression coil spring 30 in the longitudinal direction of the compression coil spring 30. The first end coil 30a and the second end coil 30c are turn portions horizontally wound around at both ends of the compression coil spring 30 and do not have a function as a spring.

A typical number of turns of the end turns is sufficient to be one. However, in the present embodiment, the first end coil 30a at the lower end of the compression coil spring 30 is longer than the second end coil 30c at the upper end of the compression coil spring 30 in the axial direction of the compression coil spring 30 to sufficiently fit the first end coil 30a into the fixing portion 29b1 of the boss 29b. The second end coil 30c at the upper end of the compression coil spring 30 may have a short length in the axial direction and a number of turns to be one because it is sufficient for the second end coil 30c to simply abut against the inner surface of the stay 25.

The compression coil spring 30 has an active coil 30b formed between the first end coil 30a and the second end coil 30c. The active coil 30b is a turn portion functioning as a spring and is used for calculation of the spring constant. The total number of turns of the compression coil spring 30 is obtained by adding the number of turns of the first end coil 30a and the second end coil 30c to the number of turns of the active coil 30b.

In FIG. 6A, the tapered portion 29b3 is inside the active coil 30b. In other words, the active coil has a portion facing the tapered portion 29b3 of the boss 29b. The active coil 30b is spaced apart from the fixing portion 29b1 in the axial direction that is the same as the insertion direction. A comparative example is described below with reference to FIGS. 13A and 13B. As illustrated in FIG. 13A, the lower end of the active coil 30b of the compression coil spring 30 in the comparative example overlaps the fixing portion 29b1. In this case, the active coil 30b overlapping the end edge of the fixing portion generates a moment that tilts the compression coil spring 30 as illustrated in FIG. 13A. As a result, as illustrated in FIG. 13B, the structure of the comparative example may cause the compression coil spring 30 to be assembled obliquely. Obliquely assembling the compression coil spring 30 to the sensor holder 29 reduces the contact pressure of the temperature sensor against the heater from a target contact pressure or shifts the contact position of the temperature sensor from a target position, which may cause an error in the detected temperature of the heater. In addition, such erroneous assembly is difficult to find by inspection after assembly, and the product defect rate becomes very high. The active coil 30b spaced apart from the fixing portion 29b1 in the axial direction as illustrated in FIG. 6A can prevent the above-described disadvantages.

Specifically, the first end coil 30a is slightly inclined (inclined upward to the left) as illustrated in FIG. 6C. As a result, a moment M acts on the first end coil 30a on a left region of the upper end edge 29b2, and the spring load P is slightly inclined to the right by the moment M.

However, the inclination is very small, and the influence of the inclination of the spring load P on the pressing force of the temperature sensor is small. As a result, a substantial error does not occur in the detected temperature of the heater.

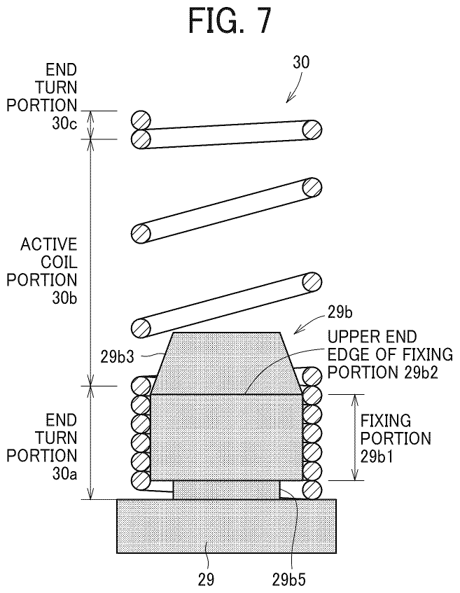

A second embodiment is described below with reference to FIG. 7.

As illustrated in FIG. 7, the boss 29b in the second embodiment has a reduced diameter portion 29b5 at a base end portion of the boss 29b. In other words, the boss 29b has the reduced diameter portion 29b5 between the fixing portion 29b1 and the holding portion 29a, and one end of the first end coil 30a faces the reduced diameter portion 29b5. The reduced diameter portion 29b5 has a diameter smaller than an inner diameter of the first end coil 30a and is separated from the first end coil 30a in a radial direction of the first end coil 30a. The axial dimension of the fixing portion 29b1 can be reduced by the amount of the reduced diameter portion 29b5. As a result, the length of the fixing portion 29b1 is smaller than the length of the first end coil 30a in the axial direction.

In rare cases, burrs may remain at the lower end of the first end coil 30a. If such burrs protrude radially inward, the burrs may interfere with the fixing portion 29b1. The burrs interfering with the fixing portion 29b1 prevents the compression coil spring 30 to be sufficiently fitted to the boss 29b and may cause the compression coil spring 30 to be erroneously assembled. The reduced diameter portion 29b5 can reduce the possibility that the insertion of the compression coil spring 30 is insufficient.

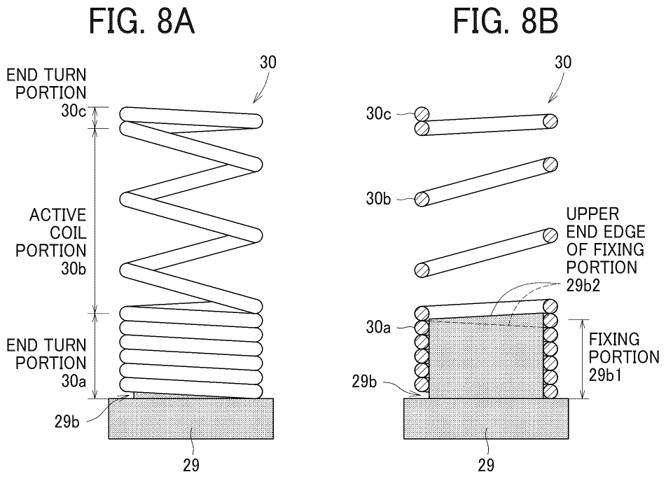

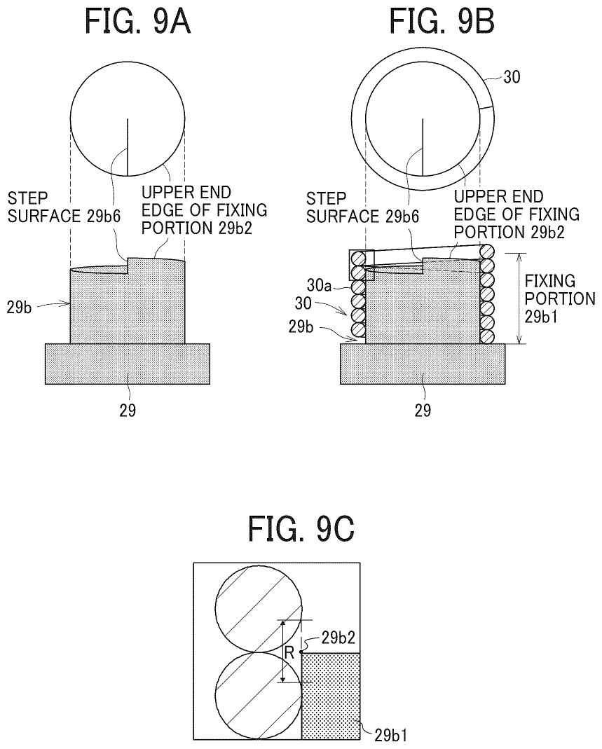

A third embodiment is described below with reference to FIGS. 8A to 9A.

As illustrated in FIGS. 8B and 9A, the fixing portion 29b1 of the boss 29b in the third embodiment has the upper end edge 29b2 inclined. Specifically, the upper end edge 29b2 is formed around a spiral inclined face as illustrated in FIG. 9A. In other words, the fixing portion 29b1 of the boss 29b has a spiral end face at the tip end of the fixing portion in the insertion direction. The inclination angle of the spiral end face is the same as the inclination angle of the first end coil 30a of the compression coil spring 30. The inclined upper end edge 29b2 formed as described above can prevent the winding of the first end coil 30a from interfering with the upper end edge 29b2 and reduce the inclination of the spring load P.

A fourth embodiment is described below with reference to FIG. 9B.

As illustrated in FIG. 9B, the winding of the first end coil 30a in the fourth embodiment is separated from the upper end edge 29b2. Specifically, as illustrated in FIG. 9C that is an enlarged view of a part surrounded by a square in FIG. 9B, the first end coil 30a and the fixing portion 29b1 are designed so that the first end coil 30a contacts the side wall of the fixing portion 29b1 and does not contact the upper end edge 29b2. In other words, as illustrated in FIG. 9C, the first end coil 30a and the fixing portion 29b1 are designed so that the position of the upper end edge 29b2 is in a range R between one point at which the winding of the first end coil 30a contacts the side wall of the fixing portion 29b1 and another point at which the winding of the first end coil 30a contacts an imaginary straight line extending from the side wall of the fixing portion 29b1 as illustrated in FIG. 9C. The above-described configuration can further prevent the winding of the first end coil 30a from interfering with the upper end edge 29b2 and reduce the inclination of the spring load P.

Note that the step face 29b6 contacts and interferes with the winding of the first end coil 30a because the step face 29b6 of the upper end edge 29b2 extends in the vertical direction (in other words, the step face 29b6 is parallel to the axis of the boss). However, there is no possibility that the spring load P is inclined.

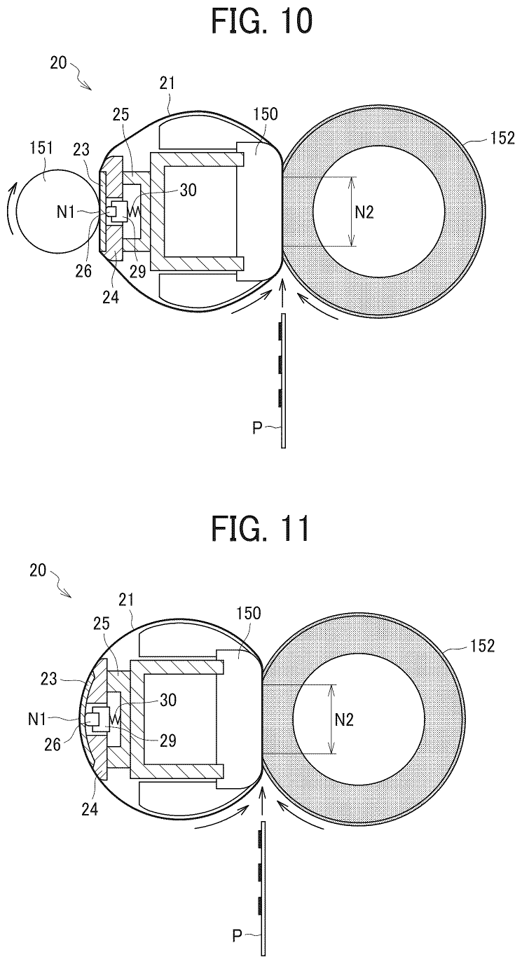

The above-described embodiments are also applicable to fixing devices having configurations different from the configuration of the fixing device in FIG. 2 as illustrated in FIGS. 10 to 12 in addition to the fixing device 20 illustrated in FIG. 2.

The configurations of fixing devices illustrated in FIGS. 10 to 12 are described below. In FIGS. 10 to 12, like reference signs are given to elements similar to those illustrated in FIG. 2, and overlapping description may be simplified or omitted as appropriate.

In the example illustrated in FIG. 10, a heating nip portion N1 and a fixing nip N2 are formed at different positions. Specifically, the fixing device 20 includes a small pressure roller 151 and a large pressure roller 152 that are positioned to face each other via the fixing belt 21. The pressure roller 151 contacts the heater 23 via the fixing belt 21 to form the heating nip N1. The pressure roller 152 contacts a nip formation pad 150 via the fixing belt 21 to form the fixing nip N2. In this case, the heater 23 generates heat to heat the fixing belt 21 in the heating nip N1 where the heater 23 contacts the fixing belt 21. The sheet P enters the fixing nip N2 where the fixing belt 21 contacts the pressure roller 152, and an unfixed image on the sheet P is heated and pressed to fix the image on the sheet P.

The fixing device 20 in FIG. 10 includes the temperature sensor 26 to detect the temperature of the heater 23 and the compression coil spring 30 as the biasing member to bias the temperature sensor 26 toward the heater 23. The stay 25 covers the compression coil spring 30.

Subsequently, the fixing device in an example illustrated in FIG. 11 omits the above-described pressure roller 151 disposed at a left side in FIG. 10 and includes the heater 23 formed to be arc having a curvature of the fixing belt 21. Other parts of the fixing device illustrated in FIG. 11 are the same as the fixing device 20 illustrated in FIG. 10. In this case, the arc-shaped heater 23 surely maintains a length of the contact area between the fixing belt 21 and the heater 23 in a belt rotation direction to efficiently heat the fixing belt 21.

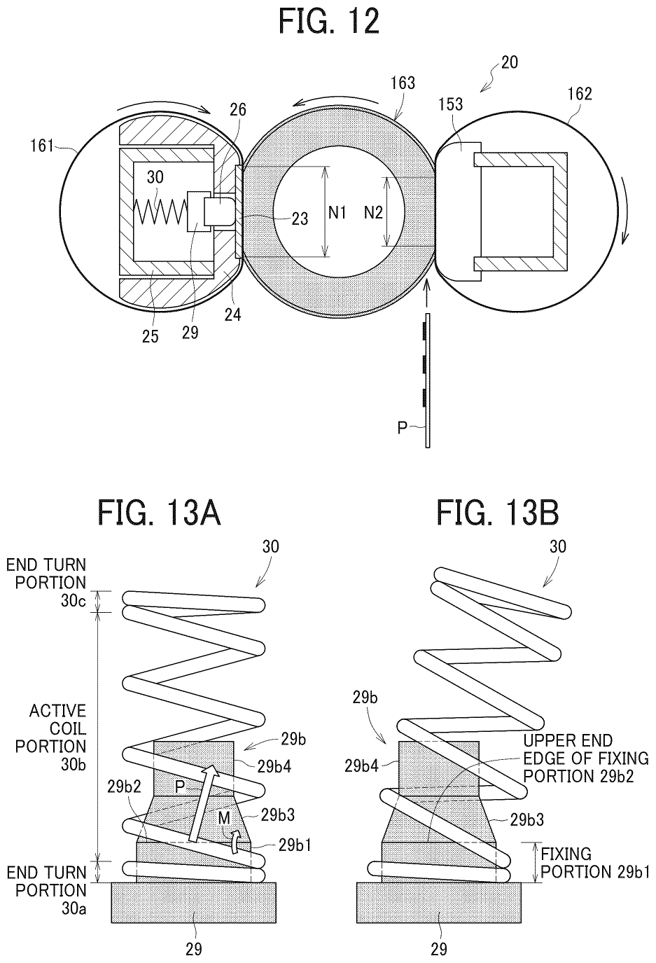

Subsequently, the fixing device 20 illustrated in FIG. 12 is described. The fixing device 20 illustrated in FIG. 12 includes a center roller 163 between two belts 161 and 162. The heater 23 is disposed inside the loop of the left belt 161 in FIG. 12 and is in contact with the center roller 163 via the left belt 161 to form the heating nip N1. A nip formation pad 153 is disposed inside the loop of the right belt 162 in FIG. 12 and is in contact with the center roller 163 via the right belt 162 to form the fixing nip N2. The heater 23 generates heat to heat the center roller 163 in the heating nip N1. The sheet P enters the fixing nip N2, and an unfixed image on the sheet P is heated and pressed to fix the image on the sheet P.

The present disclosure has been described above on the basis of the embodiments, but the present disclosure is not limited to the embodiments. Needless to say, various alterations can be made in the scope of the technical idea described in the scope of the claims. For example, the image forming apparatus according to the present disclosure is not limited to the color image forming apparatus including multiple image forming units as illustrated in FIG. 1 and may be a monochrome image forming apparatus including only one image forming unit.

The fixing device is one example of the heating device installed in the image forming apparatus. The present embodiments are not limited to applying the fixing device and may be applied to the heating device other than the fixing device. The above-described embodiments may be applied to, for example, a heating device such as a dryer to dry liquid such as ink applied to the sheet in an inkjet type image forming apparatus, a laminator that heats, under pressure, a film serving as a covering member onto the surface of the sheet such as paper, and a heat sealer that seals a seal portion of a packaging material with heat and pressure.

The above-described embodiments of the present disclosure have at least the following aspects.

### First Aspect

In a first aspect, a heating device includes a heater, a temperature sensor, a sensor holder, and a compression coil spring. The temperature sensor detects a temperature of the heater. The sensor holder holds the temperature sensor. The compression coil spring has one end supported by the sensor holder and the other end supported by the receiver. The sensor holder has a boss inserted into an inside of the one end of the compression coil spring. The boss has a fixing portion fitted into an inside of an end coil formed at the one end of the compression coil spring. An active coil is formed in a middle portion of the compression coil spring and separated from the fixing portion.

### Second Aspect

In a second aspect, the heating device according to the first aspect includes a guide formed at a tip of the fixing portion, and the guide is positioned inside the active coil of the compression coil spring.

### Third Aspect

In a third aspect, the guide in the heating device according to the second aspect has a taper tapering toward a tip of the guide.

### Fourth Aspect

In a fourth aspect, the active coil of the compression coil spring in the heating device according to the third aspect is positioned outside an outer circumferential surface of the taper.

### Fifth Aspect

In a fifth aspect, the heating device according to any one of the first to fourth aspects includes a reduced diameter portion formed at a base end portion of the boss, and the reduced diameter portion is spaced from the inner face of the end coil of the compression coil spring.

### Sixth Aspect

In a sixth aspect, the fixing portion of the boss in the heating device according to any one of the first to fifth aspects has a spiral end face at a tip end of the fixing portion, and the spiral end face has an inclination angle equal to an inclination angle of the end coil of the compression coil spring.

### Seventh Aspect

In a seventh aspect, the compression coil spring in the heating device according to the sixth aspect does not contact an end edge of the fixing portion except for a step face at an end of the spiral end face.

### Eighth Aspect

In an eighth aspect, a fixing device includes the heating device according to any one of the first to seventh aspects.

### Ninth Aspect

In a ninth aspect, an image forming apparatus includes the fixing device according to the eighth aspect.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A heating device comprising:
a heater;
a temperature sensor to detect a temperature of the heater;
a compression coil spring having:
a first end coil at one end of the compression coil spring;
a second end coil at another end of the compression coil spring; and
an active coil between the first end coil and the second end coil;
a receiver receiving the second end coil; and
a sensor holder including:
a holding portion to hold the temperature sensor at one side of the sensor holder; and
a boss, into which the first end coil is inserted in an insertion direction, to support the first end coil at another side of the sensor holder,
the boss having a fixing portion contacting an inner face of the first end coil, and the active coil spaced apart from the fixing portion in the insertion direction.

2. The heating device according to claim 1,
wherein the boss has a guide on the fixing portion, and
the active coil has a portion facing the guide of the boss.

3. The heating device according to claim 2,
wherein the guide has a taper tapering toward a tip of the guide.

4. The heating device according to claim 3,
wherein the active coil has a portion facing the taper of the guide.

5. The heating device according to claim 1,
wherein the boss has a reduced diameter portion between the fixing portion and the holding portion,
one end of the first end coil faces the reduced diameter portion, and
the reduced diameter portion has a diameter smaller than an inner diameter of the first end coil and is separated from the first end coil in a radial direction of the first end coil.

6. The heating device according to claim 1,
wherein the fixing portion of the boss has a spiral end face at a tip end of the fixing portion in the insertion direction, and
the spiral end face has an inclination angle equal to an inclination angle of the first end coil.

7. The heating device according to claim 6,
wherein the compression coil spring does not contact an end edge of the fixing portion except for a step face at an end of the spiral end face.

8. A fixing device comprising the heating device according to claim 1.

9. An image forming apparatus comprising the fixing device according to claim 8.
